(19) United States
(12) Patent Application Publication
(10) Pub. No.: US 2020/0027177 A1
(43) Pub. Date: Jan. 23, 2020

(54) Self service hotel operation system

(71) Applicants: Csaba KATÓ, Budapest (HU); Péter Palicz, Gyal (HU); Sándor Lusták, Budapest (HU); István Dienes, Budapest (HU); Csaba Kis, Budapest (HU); András Sárközi, Gyai (HU)

(72) Inventors: Csaba KATÓ, Budapest (HU); Péter Palicz, Gyal (HU); Sándor Lusták, Budapest (HU); István Dienes, Budapest (HU); Csaba Kis, Budapest (HU); András Sárközi, Gyai (HU)

(73) Assignee: Csaba Kató, Budapest (HU)

(21) Appl. No.: 16/006,781

(22) Filed: Jun. 12, 2018

(30) Foreign Application Priority Data
Mar. 2, 2018 (HU) P1800009

(51) Int. Cl. G06Q 50/12; G06Q 10/02; G06Q 10/06; H04W 76/10; H04W 60/00; H04W 4/33; H04L 29/06

(52) U.S. Cl. CPC G06Q 50/12; G06Q 10/025; G06Q 10/06311; G06F 8/60; H04W 60/00; H04W 4/33; H04L 65/4023; H04W 76/10

(57) ABSTRACT

Self service hotel operation system, comprising an internal system (10) having subsystems for carrying out different tasks including an internal PMS subsystem (14) a connection to an outer PMS subsystem (28) that service reservations and bookings, a HK subsystem (12) that carries out internal services and house cleaning tasks, a lock server (22) adjusting and controlling locks in the respective rooms, and a climate server (23) controlling the air condition means in the rooms, and a functional communication is provided between the internal system (10) and one or more travel organizers (24, 25) to perform operations connected with reservations, wherein the internal system (10) comprises an internal centre (10a) for interconnecting and coordinating the operations of said subsystems and comprises a wireless platform (11) to which any guest that wishes to use the hotel can obtain connection after downloading an application program in his/her own smart mobile device (29) and registration and entering into the system, said connection with said subsystems takes place by means of predetermined logical menus and submenus and dialogues, and the menus comprise at least options for ensuring or checking the reservations, the check in and room selection processes, the controlled payment of the expenses made during stay, then for guests having already checked in to open the room by the own mobile device (29) and finally for checking out from the hotel.

The invention relates to a self service hotel operation system in which the guest can perform all steps himself or herself starting with the room reservation, occupying the room, including everything connected with his stay, then checking out or extending the stay and paying the associated costs without the need of making any direct contact with the personnel of the hotel, whereas during his/her stay the comfort, security and the access to all services which might be needed are provided.

The system according to the invention renders even the use of personal reception services unnecessary, whereby it eliminates the spending of unnecessary time with unpleasant waiting and queuing.

In the hotel industry the utilization of the possibilities provided by computerization is in advanced state. There are numerous international and national online hotel reservation systems known and widely used (including also flight reservations and car rental services) which provide such services and they maintain permanent online connections with hotel chains and hotels. Such services include e.g. “booking.com”™, “expedia.com”™, “hotel.com”™ and several other services which provide not only reservations but also pre-payment and the ordering of several other services. These suppliers are generally referred to as “online travel agencies” and they are often abbreviated as OTA.

For the management of room reservation and other direct hotel services (e.g. wellness, car rental, different options or other rentals) several more or less self contained systems have been established which are referred to generally a “Property Management Systems” or PMS, and the internal computer systems of the respective hotels and hotel chains are in active connection with such PMS systems or with selected ones of them. The connection is generally provided by special software referred to generally as “Channel Manager”. In basic functional structures the internal computer systems of modern hotels are linked to one or more PMS system and OTA service providers and for such connections they use Channel Manager control units.

In a hotel itself several automatic sub-systems are known of which it is worth mentioning the solutions for requesting housekeeping, activating and de-activating the key or card required for entering the room and this latter mentioned services can be associated with providing power supply, the adjustment of the room temperature and the activation of wi-fi services for providing internet access.

In U.S. Pat. No. 8,805,712 such an automated inner system is described in which by means of respective touch screens arranged in the rooms there is a possibility to adjust the temperature, the “do not disturb” or “housekeeping” status and it is a possibility to check out and in given cases also to make payments or to make new reservations.

EP 2843318 A1 describes an automated room management system that can be used primarily for adjusting the status of the air conditioning system.

Such solutions are independent systems therefore they can be regarded as individual solutions, and the guests have to learn in each occasions how to handle them, and these systems do not take away the need for the guests to present themselves personally at the reception desk upon arrival even if they have valid reservations and to learn there their room number, to obtain the room keys and to get acquainted with several services provided by the hotel or to learn the wi-fi code.

The task of the invention is to provide a self service hotel operation system by which the guests will be relieved from using reception services and it will also be unnecessary that they should learn to handle different systems when using different hotels.

For solving this task we have arrived through the recognition that practically all guests have an own smart mobile device, e-mail address, bank card and they are sufficiently trained for the use of different application programs that can be downloaded into their devices, therefore a suitable application program and a matching hotel data processing centre that can interconnect the listed individual and independent systems can spare those steps for the guests which are unnecessary and time consuming for them.

With the present invention a self service hotel operation system has been provided which comprises an internal system having subsystems for carrying out different tasks including an internal PMS subsystem, a connection to an outer PMS subsystem that serves reservations and bookings, a HK subsystem that carries out internal services and house cleaning tasks, a lock server for adjusting and controlling locks in the respective rooms, and a climate server controlling the air condition means in the rooms, and a functional communication is provided between the internal system and one or more travel organizers to perform operations connected with reservations, and according to the invention the internal system comprises an internal centre for interconnecting and coordinating the operations of said subsystems and comprises a wireless platform to which any guest that wishes to use the hotel can obtain connection after downloading an application program in his/her own smart mobile device and following registration and entering into the system, said connection with said subsystems takes place by means of predetermined logical menus and submenus and dialogues, and the menus comprise at least options for ensuring or checking the reservations, the check in and room selection processes, the controlled payment of the expenses made during stay, then for guests having already checked in to open the room by their own mobile device and finally for checking out from the hotel.

It is preferred If the wireless platform comprises at least a web-based platform sensing and serving connections to a web-based wireless network functioning in the hotel, and a mobile platform ensuring connection to a public telephone network that also provides data traffic.

A further possibility lies in if on the display of the guest's mobile device respective separate fields are assigned for accessing a remote telephone support and for opening the door after the check in has been made.

It is preferred if the application program comprises separate menu options for using different internal services like room service, laundry, wellness, etc.

According to further preferences the application program comprises separate menu options for using outer services, including the ordering cabs, or outer restaurant and other reservations.

It is convenient for the guest if the application program comprises a separate option for adjusting the air condition in the room.

A further preferred option is if the application program allows the adjustment of a “do not disturb” status.

According to a further preference the application program comprises a separate option for modifying the booking and for initiating new bookings.

It is convenient for the guest if a communication between the internal centre and the HK subsystem ensures when the guest has checked in by his/her smart mobile device or after the room has been assigned to the guest, the HK system receives a notification, and on the day of the arrival of the guest the cleaning of the assigned room will be organized to have a priority in the order of cleaning rooms, and after the room has been cleaned by using the HK subsystem and the internal centre a message reporting the availability of the room is sent to the guest's mobile device.

The system according to the invention provides a realistic solution for the task set and provides a fast and convenient possibility for the guest to use all hotel services by his/her own mobile device, it renders the personal appearance at the reception desk unnecessary, and the guest will not have to store and use a separate room key. Besides these functions the system is wholly integrated and any data entered once by the guest will not be required for any repeated entry.

The invention will now be described in connection with an exemplary embodiment thereof, in which reference will be made to the accompanying drawings. In the drawing:

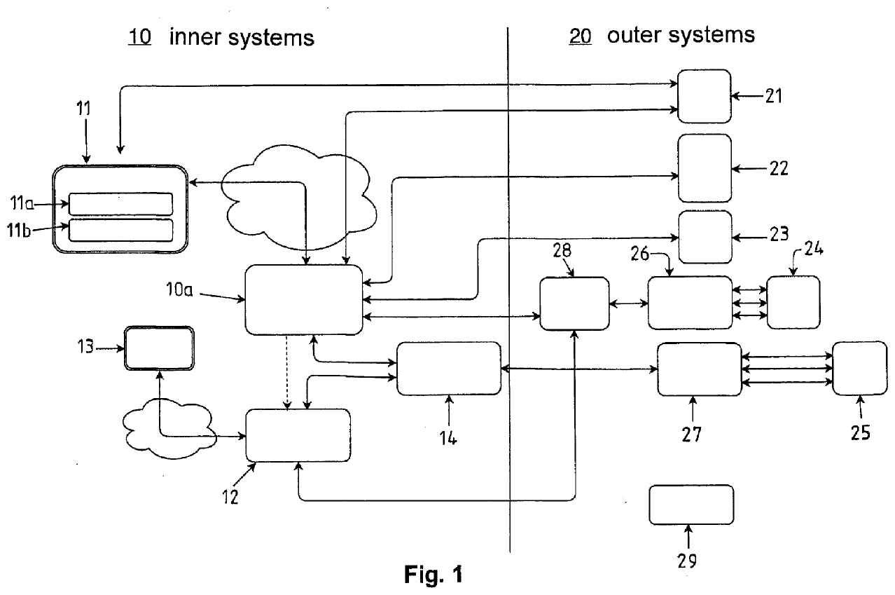

FIG. 1 shows the simplified block diagram of the system according to the invention;

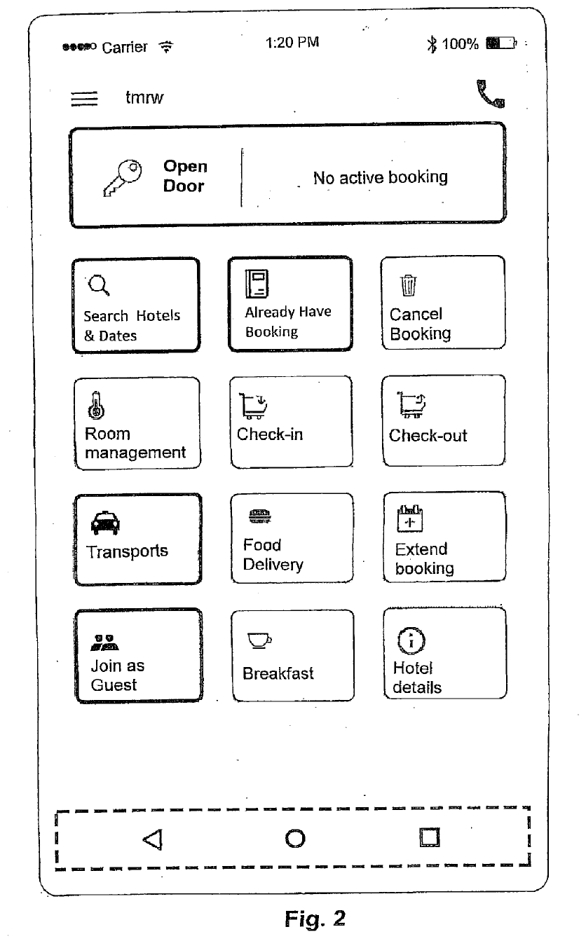

FIG. 2 shows a first version of the menu displayed on the mobile device of the guest; and

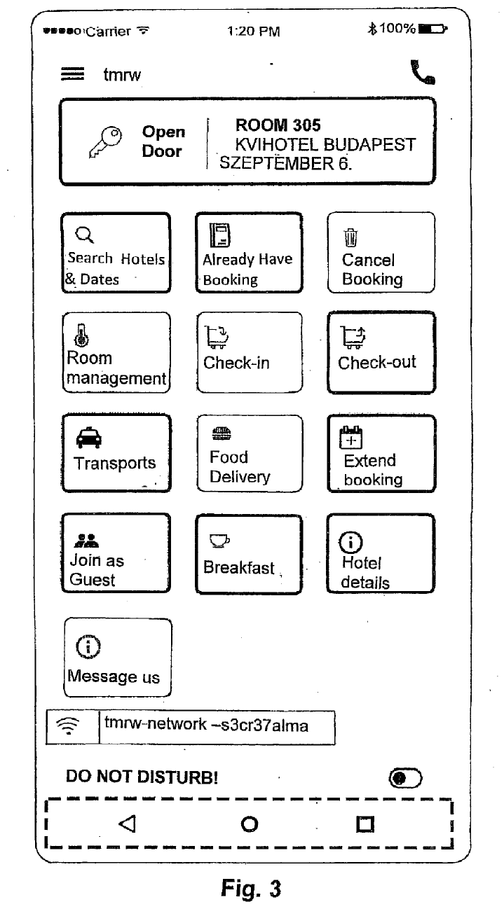

FIG. 3 shows the menu of FIG. 2 in a state following the registration.

FIG. 1 shows the general block diagram of the system according to the invention. The vertical dash line in the middle of the figure divides the elements into two parts in which in the left half area is assigned to parts of outer systems 20 and the other left half area is assigned to internal systems 10 which belong to the hotel or to the hotel chain. Out of the own units internal centre 10a indicates the primary main machine system of the hotel or hotel chain which is also referred to in the drawing as unit TMRW. The programs stored therein enable the operation as described later. The internal centre 10a can communicate with elements that form part of the system but also which are only temporarily connected to the system through two wireless platforms 11, namely web-based platform 11a and mobile platform 11b which latter mainly designates public mobile communication networks.

Within the hotel the systems that carry out internal services like cleaning, tidying and internal services are referred to as HK systems 12 (HK being the abbreviation of the expression “House Keeping”), and the HK system 12 is in permanent two-way connection with the internal centre 10a. To reach the persons who belong to the HK system 12 specific HK mobile devices 13 are used, which are generally smart phones of android type or other special wireless units. In optional cases an own PMS sub-system 14 also belongs to the internal system 10 which is programmed to carry out the tasks which are generally assigned to PMS systems.

The outer systems 20 comprises payment server 21 used for performing payments, a lock server 22 which has the task of controlling the locks in the respective rooms, a climate server 23 that controls the air condition systems in the respective rooms according to actual local needs, furthermore the respective OTA travel organizers 24, 25 and channel controllers 26, 27 that enable connections towards OTA travel organizers 24, 25. In case (which takes place rather often) the hotel does not have an own PMS sub system 24 or if beside it the hotel also uses an outer PMS subsystem 28, then this PMS sub system 28 also belongs to the outer systems 20. Finally, from the point of view of system design a mobile device 29 of a guest visiting the hotel also belongs to the outer system 20 which can be connected to the internal system 10 either through the web-based platform 11a or the mobile platform 11b.

A guest can be able to use the hotel system after having downloaded in his/her mobile device 29 a TMRW application which can be freely accessed and downloaded that enables the use of the system either through a web-based connection or through the mobile service with the own mobile device 29. Following the downloading of the application the guest has to register in the system that requires a username and a password, then for the actual use the guest shall provide his/her personal data including e-mail address and home address and all further data which are generally required for hotel registrations. These data should be provided, however, only once. Among the data (at least if the guest wishes to make a valid reservation) a kind of wireless payment method should be provided (e.g. credit or debit card data, pay-pal data, etc.).

As it was mentioned earlier, the use of the hotel system can be divided basically into two versions, namely if the given hotel uses a known PMS subsystem 28 or a specifically designed own internal PMS subsystem 14.

The internal centre 10a has the task of coordinating the functions of the different subsystems so that the guest after having downloaded the application can easily access each of them.

Although the operation of a hotel has a high number of details and branches, and the full explanation thereof would exceed the limits of the present application, in the following the main characteristics of the registration and use will be described to demonstrate that the use of a reception service is unnecessary whereas the guest can have access to all services which are required for his/her stay in a comfortable and secure way. For providing such a service a remote dispatcher service has been provided which is available round the clock and this can be also called as “remote reception”.

Following the downloading of the application when the guest opens the application will see a menu which is illustrated in FIG. 2. The first option of the menu is the “search hotels and dates” and after opening this option the guest can conveniently make a reservation to the required periods. This option is, however, not mandatory because a reservation made through a travel organizer can also be used. In case the guest has a reservation and wishes to modify or cancel it, then this can be made by selecting the “already have booking” option. The menu system is designed in such a way that for the guest only the options can be activated at any stage which can be chosen at the given occasion, and these fields have been drawn by heavy lines while the fields that cannot be chosen were drawn by light lines. For example if the guest has not yet checked in, then he cannot use the options available by the guests of the hotel.

The check in can be made in a single step or in two steps. The two step check in can be started e.g. in two days before the date of the planned arrival when the guest has some free time to do it. Such free time can happen during flight transfer waiting periods, at other waiting periods or in a cab or in a train. This check in step represents substantially the confirmation of the reservation, its activation that activates the reservation in the internal centre 10a of the hotel that opens the account provided for that guest, and in given cases an amount corresponding to the expectable costs will be frozen in the guest's account, and if the time of the arrival and of the time when the room will be taken is known, then the option for designating or choosing the room will become available for the guest. In that case the guest can choose the room. During check in the HK system 12 will prioritize the designated or selected rooms in the order of the daily room cleaning, and if the room has been cleaned and it is ready for receiving the guest, this fact will be reported by the HK system 12 to the internal centre 10a in the form of a message and from here the guest will receive either an e-mail or an sms message. At the same time this also means that the guest will not have to wait till the general check-in time (e.g. 2 pm.) guaranteed normally by the hotels but after having received the “room ready” information the room can be taken.

The selection of the room can take place also after the check in step. The HK system 12 receives information on the selection of the room and will see to that the room will be available in cleaned state for the guest as soon as possible but latest by the chosen time. During check in the names and number of the guests should be confirmed i.e. the guest will see that according to the reservation who requested the room and if actually the previously reserved persons have arrived then the guest should simply accept it but if any change is experienced, the changes can entered at this step.

When the guest enters the hotel, the own mobile device 29 gets connected to the wireless system (WI FI) of the hotel and by means of the application program a connection will be established between the mobile device 29 of the guest and the internal system 10 of the hotel.

The options of the menu appearing on the mobile device 29 of the guest will become as shown in FIG. 3. The guest sees that he can take the room #305 and through the internal centre 10a and the HK system 12 controlled by the centre the electronic key of the room 305 will be downloaded into the mobile device 29 of the guest and it will be in active state, and when the guest arrives in front of the room 305 he can open the door by using the “open door” option.

Of course, this activation requires that by the time the guest arrives at the hotel, the room 305 will be cleaned. If the guest arrives earlier then the expected time, then instead of the active status of the room a message will be displayed according to which the room can be taken only at a later time. In that case the guest can suggest the assignment of a different (already cleaned) room or accepts the waiting and will take the room only when the status “room ready” is displayed. Such a situation occurs only in exceptional cases, because according to the previously provided explanation after the guest has checked in, the cleaning of the room enjoys a priority for the housekeeping and the guest receives a separate message that the room has become available.

The check-in with a single step differs from this only in that the guest waits with the check-in step until arrival in the hotel.

In the menu shown in FIG. 3 the guest can choose any option of which the followings are mentioned (the list does not comprise all options):

Pushing the field “Calling a cab, food order” a separate page will open that enables calling a cab or placing food orders.

Pushing the field “room functions” the appropriate page opens in which the user can choose among different room-related options. Such options include the adjustment of the room temperature, or using the “do not disturb” indication, etc.

Pushing the field “extend booking” there is a possibility to extend the reservation and the application will navigate the guest to an appropriate new page.

Pushing the field “cancel booking” assists in canceling a reservation.

In case of any service in which there are selectable options for the guest an appropriate submenu will appear which helps choosing the preferred option. In case of placing an order connected with costs the associated amount will be displayed and the guest receives a message when such an option is chosen.

In the internal system 10 to each guest an individual identification code (token) will be assigned, and all events associated with the stay of the guest will be interlaced by the token which also forms the basis of invoicing.

If in any given room more than one guest will stay, then the second and further guests will have the possibility to download the application program and to associate that guest to the booking concerned, i.e. he/she will also obtain the electronic room key. If this additional guest does not wish to download the application program then there is a possibility to request a key which will be placed in the room after the associated order has been received.

In the upper field of the main menu of the application there is a figure of a telephone receiver that corresponds to a “support” or “assistance” function, and if it is pushed then the guest will be connected to the manager on duty of the hotel with whom the guest can discuss any specific request or problem.

By selecting the “check out” function the guest indicates to the internal system 10 his intention to leave the hotel, whereby the possibility of further using the services on his code will become closed with the exception of a few services (e.g. ordering a cab, using the wellness or fitness services or departing from the parking lot), and the summary of the previously used services will be displayed in the form of a draft invoice which should be approved by the guest. The correction of any item can be made by pressing the phone receiver icon. By the validation of the invoice and the sending of an appropriate message that the checkout has been carried out, from then or from the departure time indicated by the guest the room key function of the guest's mobile device 29 will become invalid. It is also true for the check out that it does not need to take place in the hotel area and the guest can perform it at any appropriate place and time. Naturally, at the end of a predetermined check out period the hotel can automatically initiate the check out.

The essence of the hotel operation system according to the invention lies in that the previously known but separately used subsystems will be coordinated by the internal centre 10a based on the communication with the mobile device 29 of the guest after the specific application program has been downloaded into the mobile device 29. During use the guest can monitor and follow the processes connected with his/her reservation and stay that starts with the booking and includes all services that the guest has used during his/her stay then includes the check out and the invoicing without the need for the guest to present himself or herself at the reception desk and stay any line there. For carrying out these steps the guest will have to use only his own mobile device 29 and there will be no need of using any reception service in the hotel.

1. Self service hotel operation system, comprising an internal system (10) having subsystems for carrying out different tasks including an internal PMS subsystem (14), a connection to an outer PMS subsystem (28) that serves reservations and bookings, a HK subsystem (12) that carries out internal services and house cleaning tasks, a lock server (22) adjusting and controlling locks in the respective rooms, and a climate server (23) controlling the air condition in the rooms, and a functional communication is provided between the internal system (10) and one or more travel organizers (24, 25) to perform operations connected with reservations, characterized in that the internal system (10) comprises an internal centre (10a) for interconnecting and coordinating the operations of said subsystems and comprises a wireless platform (11) to which any guest that wishes to use the hotel can obtain connection after downloading an application program in his/her own smart mobile device (29) and following the registration and entering into the system, said connection with said subsystems takes place by means of predetermined logical menus and submenus and dialogues, and the menus comprise at least options for ensuring or checking the reservations, the check in and room selection processes, the controlled payment of the expenses made during the stay, then for guests having already checked in to open the room by the own mobile device (29) and finally for checking out from the hotel.

2. The hotel operation system as claimed in claim 1, wherein the wireless platform (11) comprises at least a web-based platform (11a) sensing and serving connections to a web-based wireless network functioning in the hotel, and a mobile platform (11b) ensuring connection to a public telephone network that also provides data traffic.

3. The hotel operation system as claimed in claim 1, wherein on the display of the guest's mobile device (29) respective separate fields being assigned for accessing a remote telephone support and for opening the door after the check in has been made.

4. The hotel operation system as claimed in any of claim 1, wherein the application program comprises separate menu options for using different internal services like room service, laundry, wellness, etc.

5. The hotel operation system as claimed in any of claim 1, wherein the application program comprises a separate menu option for using outer services, including the ordering of cabs or reservations in outer restaurants and other kinds of reservations.

6. The hotel operation system as claimed in any of claim 1, wherein the application program comprises a separate option for adjusting the air condition in the room.

7. The hotel operation system as claimed in any of claim 1, wherein the application program comprises a separate option for the adjustment of a “do not disturb” status.

8. The hotel operation system as claimed in any of claim 1, wherein the application program comprises a separate option for modifying the booking and for initiating new bookings.

9. The hotel operation system as claimed in any of claim 1, wherein a communication between the internal centre (11a) and the HK subsystem (12) ensures when the guest has checked in by his/her smart mobile device (29) or after the room has been assigned to the guest, the HK system (12) receives a notification, and on the day of the arrival of the guest the cleaning of the assigned room will be organized to have a priority in the order of cleaning rooms, and after the room has been cleaned by using the HK subsystem (12) and the internal centre (10a) a message reporting the availability of the room is sent to the guest's mobile device (29).
